(19) United States
(12) Patent Application Publication
(10) Pub. No.: US 2015/0293914 A1
(43) Pub. Date: Oct. 15, 2015

(54) MULTIMEDIA INFORMATION PROCESSING METHOD, MULTIMEDIA APPARATUS, AND MULTIMEDIA NETWORK SYSTEM

(71) Applicant: GEMTEK TECHNOLOGY CO., LTD., HSINCHU COUNTY (TW)

(72) Inventor: HSIANG-CHUN LIU, HSINCHU COUNTY (TW)

(21) Appl. No.: 14/335,900

(22) Filed: Jul. 19, 2014

(30) Foreign Application Priority Data
Apr. 9, 2014 (TW) 103113059

(51) Int. Cl. G06F 17/30

(52) U.S. Cl. CPC G06F 17/30023; G06F 17/30058; G06F 17/30935

(57) ABSTRACT

An exemplary embodiment of the present disclosure illustrates a multimedia apparatus linked to at least a multimedia sever. For each of the top first level nodes, among the top second level nodes under the first level node, the multimedia apparatus finds second level node with the maximum child node count. The multimedia apparatus stores object identifications and the child node counts of partial found second level nodes as a part of multimedia information. The multimedia apparatus can efficiently reduce computation amount, memory usage, storage space usage, and network traffic amount.

### BACKGROUND

1. Technical Field

The present disclosure relates to a multimedia apparatus, in particular to a multimedia apparatus, a multimedia network system, and a multimedia information processing method for digital living network alliance (DLNA).

2. Description of Related Art

DLNA is an industrial standard allowing digital apparatus in a local area network (LAN) to play, share, or print multimedia files of different formats. DLNA is developed based universal plug and play (UPnP), and can integrate contents of digital multimedia, such that pictures, music, videos, and playlists can be shared easily.

The apparatus for DLNA can be categorized into a digital media server (DMS), a digital media player (DMP), a digital media controller (DMC), or a digital media renderer (DMR). The DMS can send a description file of at least one media file to the DMP or DMC, such that the DMP can play the at least one media file by using the description file of the least one media file, or alternatively, the DMC can play the at least one media file on the DMR by using the description file of the least one media file. In short, the user can store the at least one multimedia file in the DMS (e.g. computer, mobile phone, digital video recorder, digital camera), and then use the DMP to browse the multimedia file through the network.

In a DLNA system, the user can use the DMP to request browse action for the DMS, such that the DMS correspondingly generates response information in extensible markup language (XML) format to the DMP. The DMP analyzes the response information in XML format, so as to obtain information of the node currently browsed, and the information is presented for the user by using any possible presentation manner. The user can acquire the information displayed by the DMP, and then selectively request the browse action for the child node or return action for the parent node.

However, under the congested network, operation procedure of the browse action easily cause the user to wait the dedicated DMS to response the response information in XML format for long time. In addition, when the document to be browsed locates at the lower location of the directory structure, the DMS must consume longer time to look over the directory structure to response the DMP. In short, the manner for browsing the multimedia files stored in the DMS is not convenient and intuitive for the user.

### SUMMARY

An exemplary embodiment of the present disclosure provides a multimedia apparatus linked to a multimedia server, and the multimedia apparatus comprises a transmitting unit, a receiving unit, a storage unit, and a processing unit, wherein the processing unit is electrically connected to the transmitting unit, the receiving unit, and the storage unit. The transmitting unit transmits a browse action command to the multimedia server, such that the multimedia server generates response information according to the browse action command. The receiving unit receives the response information. The storage unit stores multimedia information. The processing unit generates the browse action command, and analyzes the response information, so as to generate multimedia information. The multimedia server has a root node, there are first level nodes under the root node, and there are second level nodes under each of the first level nodes. For each of the top first level nodes, among the top second level nodes under the first level node, the processing unit finds the second level node with a maximum child node count. Then the processing unit indicates the storage unit to store object identifications and the child node counts of partial found second level nodes as a part of the multimedia information.

An exemplary embodiment of the present disclosure provides a multimedia network system comprising at least one multimedia apparatus and at least one multimedia server, wherein the multimedia server is linked to the multimedia apparatus, and has a root node. There are first level nodes under the root node, and there are second level nodes under each of the first level nodes. The multimedia apparatus obtains object identifications of top first level nodes. For each of the top first level nodes, among the top second level nodes under the first level node, the multimedia apparatus finds the second level node with the maximum child node count, and then obtains the object identification and the child node count of the found second level node. For each of the found second level nodes, if one child node under the found second level node is the multimedia file, the multimedia apparatus stores the object identification and the child node count of the found second level node as a part of multimedia information.

An exemplary embodiment of the present disclosure provides a multimedia information processing method executed in a multimedia apparatus, wherein the multimedia apparatus is linked to a multimedia server, there are first level nodes under the root node, and there are second level nodes under each of the first level nodes. Steps of the multimedia information processing method are illustrated as follows. The multimedia apparatus obtains object identifications of top first level nodes. For each of the top first level nodes, among the top second level nodes under the first level node, the multimedia apparatus finds the second level node with the maximum child node count, and then obtains the object identification and the child node count of the found second level node. For each of the found second level nodes, if one child node under the found second level node is the multimedia file, the multimedia apparatus stores the object identification and the child node count of the found second level node as a part of multimedia information.

To sum up, the multimedia apparatus and multimedia information processing method in exemplary embodiments of the present disclosure can obtain object identifications and child node counts of the documents corresponding to the multimedia files, and do not need to look over the whole directory structure. Thus, computation amount, memory usage, storage space usage, and network traffic amount can be dramatically reduced.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram showing architecture of a multimedia network system according to an exemplary embodiment of the present disclosure.

FIG. 2A is a schematic diagram showing a tree directory structure of multimedia server according to an exemplary embodiment of the present disclosure.

FIG. 2B is a schematic diagram showing a tree directory structure of multimedia server according to another one exemplary embodiment of the present disclosure.

FIG. 3 is a schematic diagram showing a data structure of multimedia information stored by a multimedia apparatus according to an exemplary embodiment of the present disclosure.

FIG. 4 is a schematic diagram of a channelization browse interface provided by the multimedia apparatus according to an exemplary embodiment of the present disclosure.

FIG. 5 is a block diagram of a multimedia apparatus according to an exemplary embodiment of the present disclosure.

FIG. 6A is a flow chart of a multimedia information processing method according to an exemplary embodiment of the present disclosure.

FIG. 6B-1 and FIG. 6B-2 are a flow chart of a multimedia information processing method according to another one exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

An exemplary embodiment of the present disclosure provides a multimedia network system comprising at least one multimedia apparatus and at least one multimedia sever, wherein the multimedia apparatus can execute a multimedia information processing method. The main concept of the present disclosure is briefly illustrated as follows.

The multimedia apparatus performs browse action for the multimedia sever to request response information (such as response information in XML format), and a browse action command can be expressed as BROWSE(ObjectID, RequestCount), wherein ObjectID is an object identifications of a node to be browsed, and RequestCount is an information request number of child nodes under the node to be browsed. Generally, the objection identification of the root node is 0, when the browse action command is BROWSE(ObjectID=0, RequestCount=0), information of all child nodes under the root node (i.e. all first level nodes) is acquired. When the browse action command is BROWSE(ObjectID=0, RequestCount=2), information of top two child nodes under the root node (i.e. top two first level nodes) is acquired.

After the multimedia server receives the browse action command, the multimedia sever generates the response information. The response information comprises the object identification of the parent node associated with the node to be browsed, the child node counts of the node to be browsed, the object identifications of the child nodes of the node to be browsed, and types of the child nodes associated with the node to be browsed. For example, when the browse action command is BROWSE(ObjectID=0, RequestCount=2), information including the child node counts of the root node, the object identifications and types of the top two child nodes associated with the root node (i.e. top two first level nodes) is responded to the multimedia apparatus.

Firstly, the multimedia apparatus performs a browse action for the multimedia server to obtain object identifications of the top first level nodes under the root node (i.e. top two child nodes under the root node). Then, for each of the top first level nodes, by using the object identification of the first level node, the multimedia apparatus performs another browse action for the multimedia server to find a second level node with a maximum child node count among top second level nodes (i.e. top child nodes of the first level node). The found second level nodes may be the documents of “all pictures”, “all music”, and “all videos”. Thus, for each of the found second level nodes, the multimedia apparatus checks whether one child node of the found second level node is a multimedia file, and the multimedia apparatus stores the object identification and the child node count of the found second level node as a part of the multimedia information when the one child node of the found second level node is the multimedia file. Therefore, the object identifications and the child node counts of the found second level nodes are substantially the object identifications and the child node counts of the documents associated with “all pictures”, “all music”, and “all videos”. In short, the object identifications and the child node counts of partial found second level nodes can be stored as the part of the multimedia information.

Moreover, the multimedia apparatus can present the multimedia information by a using channelization browse interface to the user, such that the user can intuitively select the multimedia file to be watched or listened. For example, the all pictures under the document of “all pictures” belong to a first channel, the all music under the document of “all music” belongs to a second channel, the all videos under the document of “all videos” belong to a third channel.

The implementations and details of the multimedia network system, the multimedia apparatus, and the multimedia information processing method are illustrated as follows.

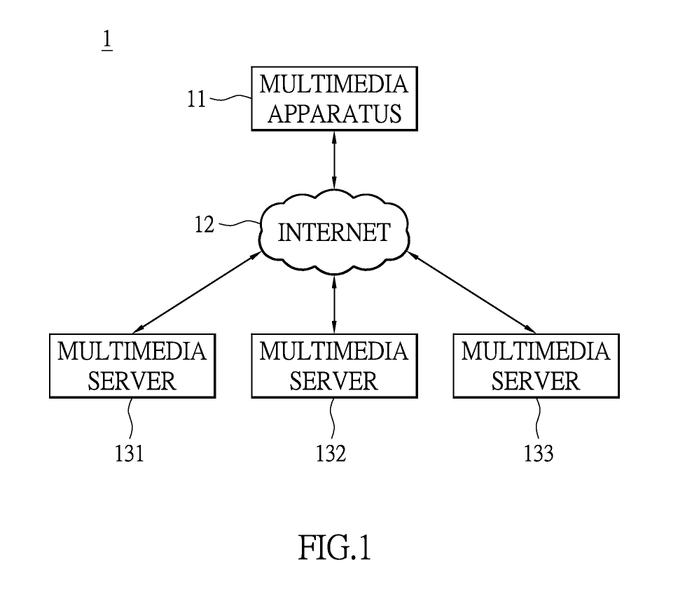

Referring to FIG. 1, FIG. 1 is a schematic diagram showing architecture of a multimedia network system according to an exemplary embodiment of the present disclosure. The multimedia network system 1 comprises at least one multimedia apparatus 11 and at least one of multimedia severs 131 through 133, wherein the multimedia apparatus 11 links to the multimedia severs 131 through 133 via the internet network 12. The multimedia severs 131 through 133 can be DMSs for storing multimedia files of different types. The multimedia apparatus 11 can be a DMP or DMC.

After the multimedia severs 131 through 133 establish a link with the multimedia apparatus 11, or alternatively, when the multimedia severs 131 through 133 have the multimedia files to be updated, the multimedia apparatus 11 obtains the multimedia information of the multimedia severs 131 through 133. Furthermore, the multimedia apparatus 11 preferably presents the multimedia information to the user by using the channelization browse interface.

In the exemplary embodiment of the present disclosure, the multimedia apparatus 11 can selectively polls the multimedia severs 131 through 133 whether they support a search command. When one of the multimedia severs 131 through 133 supports the search command, for example the multimedia server 131, the multimedia sever search its multimedia files to generate the multimedia information to the multimedia apparatus 11. The multimedia apparatus 11 performs the browse action for the multimedia severs 132 and 133 to obtain their multimedia information.

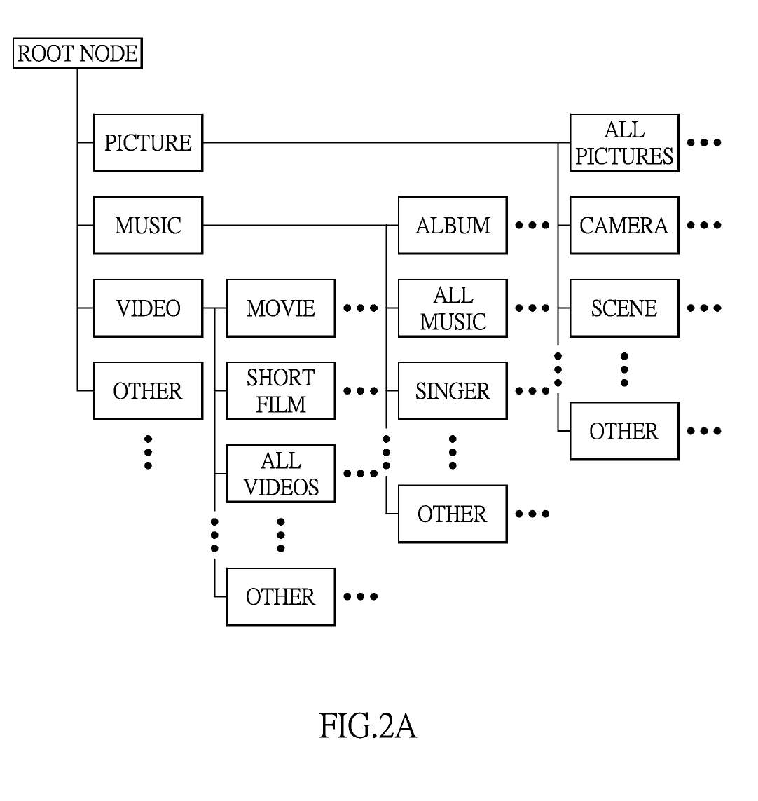

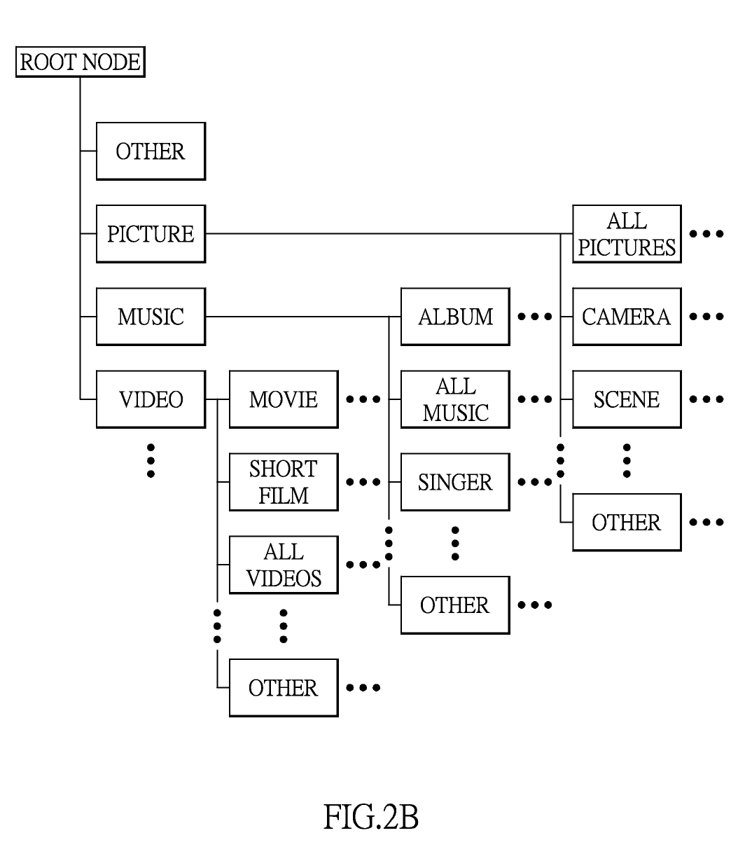

Referring to FIG. 2A and FIG. 2B, FIG. 2A is a schematic diagram showing a tree directory structure of multimedia server according to an exemplary embodiment of the present disclosure, and FIG. 2B is a schematic diagram showing a tree directory structure of multimedia server according to another one exemplary embodiment of the present disclosure.

In FIG. 2A, the top four child nodes of the root node (i.e. top four first level nodes) are respectively the documents of “picture”, “music”, “video”, and “other”. The top one child node under the document of “picture” is the document of “all pictures”, and other child nodes under the document of “picture” are the document of “camera”, “scene”, and “other”. Among the documents of “all pictures”, “camera”, “scene”, and “other”, the document of “all pictures” has the maximum child node counts. The top one child node under the document of “music” is the document of “all music”, and the other child nodes under the document of “music” are the document of “album”, “singer”, and “other”. Among to the documents of “all music”, “album”, “singer”, and “other”, the document of “all music” has the maximum child node counts. The top one child node under the document of “video” is the document of “all videos”, and the other child nodes under the document of “video” are the document of “short film”, “movie”, and “other”. Among to the documents of “all videos”, “short film”, “movie”, and “other”, the document of “all videos” has the maximum child node counts.

In the tree directory structure of FIG. 2B, the top four child nodes under the root node (i.e. top four first level nodes) are respectively the documents of “other”, “picture”, “music”, and “video”. The sub tree directory structures under the documents of “picture”, “music”, and “video” are the same as those under the documents of “picture”, “music”, and “video” in FIG. 2A, and the repeated descriptions are omitted.

The following descriptions are given under the assumption that the tree directory structures in FIG. 2A and FIG. 2B respectively belong to the multimedia servers 132 and 133 for example. The multimedia apparatus 11 sends the browse action command BROWSE(ObjectID=0, RequestCount=4) to the multimedia sever 132, so as to obtain the object identifications of the top four first level nodes under the root node, i.e. the object identifications of the documents of “picture”, “music”, “video”, and “other”, and theses four identifications are 1, 2, 3, and 4 for example.

Next, the multimedia apparatus 11 sends the browse action command BROWSE(ObjectID=1, RequestCount=4) to the multimedia sever 132, so as to obtain the object identification and the child node count of the second level node with the maximum child node count among the top four second level nodes associated with the document of “picture”, that is, the object identification (being 5 for example) and the child node count of the document of “all pictures”. In the similar manner, the multimedia apparatus 11 sends the browse action commands BROWSE(ObjectID=2, RequestCount=4), BROWSE(ObjectID=3, RequestCount=4), and BROWSE(ObjectID=4, RequestCount=4) to the multimedia sever 132, so as to obtain the object identifications and the child node counts of the second level nodes with the maximum child node counts among the top four second level nodes associated with the documents of “music”, “video”, and “other”. That is, the three object identifications are object identifications (being 9 and 13 for example) of the documents of “all music” and “all videos”, and the object identification (being 18 for example) of one second level node associated with the document of “other” under the root node.

Then, the multimedia apparatus 11 checks the type of one child node under each of the second level nodes with the maximum child node counts. The multimedia apparatus 11 sends the browse action commands BROWSE(ObjectID=5, RequestCount=1), BROWSE(ObjectID=9, RequestCount=1), BROWSE(ObjectID=13, RequestCount=1), and BROWSE(ObjectID=18, RequestCount=1) to the multimedia sever 132, so as to recognize that the child nodes under the document of “all picture”, “all music”, and “all videos” are respectively the picture, music, and video files, and the one child node under the second level node of the document of “other” under the root node is not a multimedia file (p.s. generally this child node is not the multimedia file, and the processing for the exception case is illustrated latter). Next, the multimedia apparatus 11 stores the object identifications and the child node counts of the documents “all picture”, “all music”, and “all videos” as the part of the multimedia information.

Regarding the multimedia sever 133, the multimedia apparatus 11 sends the browse action command BROWSE(ObjectID=0, RequestCount=4) to the multimedia sever 133, so as to obtain the object identifications of the top four first level nodes under the root node, i.e. the object identifications of the documents of “other”, “picture”, “music”, and “video”, and theses four identifications are 1, 2, 3, and 4 for example.

Next, the multimedia apparatus 11 sends the browse action command to the multimedia sever 133, so as to obtain the object identification (being 5 for example) and the child node count of the second level node with the maximum child node count among the top four second level nodes of the document of “other” under the root node. In the similar manner, the multimedia apparatus 11 sends the browse action commands BROWSE(ObjectID=2, RequestCount=4), BROWSE(ObjectID=3, RequestCount=4), and BROWSE(ObjectID=4, RequestCount=4) to the multimedia sever 132, so as to obtain the object identifications and the child node counts of the second level nodes with the maximum child node counts among the top four second level nodes associated with the documents of “picture”, “music”, and “video”. That is, the three object identifications of the second level nodes with the maximum child node counts are the object identifications (being 9, 13, and 18 for example) of the documents of “all pictures”, “all music”, and “all videos”.

Then, the multimedia apparatus 11 checks the type of one child node under each of the second level nodes with the maximum child node counts. The multimedia apparatus 11 sends the browse action commands BROWSE(ObjectID=5, RequestCount=1), BROWSE(ObjectID=9, RequestCount=1), BROWSE(ObjectID=13, RequestCount=1), and BROWSE(ObjectID=18, RequestCount=1) to the multimedia sever 133, so as to recognize that the child nodes under the document of “all picture”, “all music”, and “all videos” are respectively the picture, music, and video files, and the one child node under the second level node of the document of “other” under the root node is not a multimedia file (p.s. generally this child node is not the multimedia file, and the processing for the exception case is illustrated latter). Next, the multimedia apparatus 11 stores the object identifications and the child node counts of the documents “all picture”, “all music”, and “all videos” as the part of the multimedia information.

It is noted that, in descriptions of the above exemplary embodiment that he multimedia apparatus obtains the object identifications of the first level nodes and the second level nodes, the value of RequestCount is equal to 4 that t, but the present disclosure does not limit the value of RequestCount. The value of RequestCount can be preferably less than or equal to 4. For example, in the tree directory structure of FIG. 2A, the value of RequestCount can be equal to 3, such that the number of browse actions can be decreased. Furthermore, in the exemplary embodiment, it can be known that the multimedia apparatus 11 merely performs 9 browse actions to obtain the multimedia information of the multimedia sever 132 or 133.

In addition, since the second level node with the maximum child node count under the document of “other” associated with first level node may have a child node being the multimedia file, the obtained multimedia information may not be correct. Thus, after whether the one child node of each of the second level nodes with the maximum child node counts is the multimedia file is checked, if these child nodes are multimedia files, for each of the two second level nodes having the child nodes with the same types, the multimedia apparatus 11 further check the types of the partial child nodes (p.s. the number of the partial child nodes is less than the maximum child node count) of the second level node are identical to each other. If the types of the partial child nodes of the second level node are not identical to each other, it means the object identification and the child node count of the second level node is the incorrect multimedia information. Thus, the multimedia apparatus 11 does not store the object identification and the child node count of the second level node. If the types of the partial child nodes of the second level node are identical to each other, it means the object identification and the child node count of the second level node is the correct multimedia information. Thus, the multimedia apparatus 11 stores the object identification and the child node count of the second level node.

Referring to FIG. 2A, if the child nodes of the second level node with the maximum child node count under the document of “other” associated with the first level node of the multimedia sever 132 are respectively the picture files, the music files, and directories, as mentioned above, the object identification and child node count of the second level node with the maximum child node count under the document of “other” associated with the first level node of the multimedia sever 132 is mistakenly stored as a part of the multimedia information. Thus, the multimedia apparatus 11 sends the browse action commands BROWSE(ObjectID=5, RequestCount=1) and BROWSE(ObjectID=18, RequestCount=1) to the multimedia sever 132, and through the response information from the multimedia sever 132, the multimedia apparatus 11 recognizes that the one child node of the second level node with the maximum child node count under the document of “other” and the one child node of the document of “all pictures” are picture files.

Next, the multimedia apparatus 11 sends the browse action commands BROWSE(ObjectID=5, RequestCount=k1) and BROWSE(ObjectID=18, RequestCount=k2) to the multimedia sever 132, wherein k1 and k2 are respectively less than or equal to the corresponding maximum child node counts respectively. For example, the second level node with the maximum child node count under the document of “other” has 200 child nodes, the document of “all pictures” has 100 child nodes, and thus k1 and k2 can be 200 and 100 respectively. When the computation complexity and the transmission amount are considered, and the little error probability is allowed, k1 and k2 can be 4 in the above exemplary embodiment. When the tradeoff of the accuracy, the computation complexity, and the transmission amount is considered, k1 and k2 are preferably the 50% through 100% of the corresponding maximum child node counts.

After the multimedia apparatus 11 sends the browse action commands BROWSE(ObjectID=5, RequestCount=k1) and BROWSE(ObjectID=18, RequestCount=k2) to the multimedia sever 132, through the response information of the multimedia sever 132, the multimedia apparatus 11 recognizes that the types of the k1 child nodes of the second level node with the maximum child node count under the document of “other” are not identical to each other, and the k2 child nodes of the document of “all pictures” are picture files. Thus, multimedia sever 132 does not mistakenly store the object identification and the child node count of the second level node with the maximum child node count under the document of “other” as the part of the multimedia information.

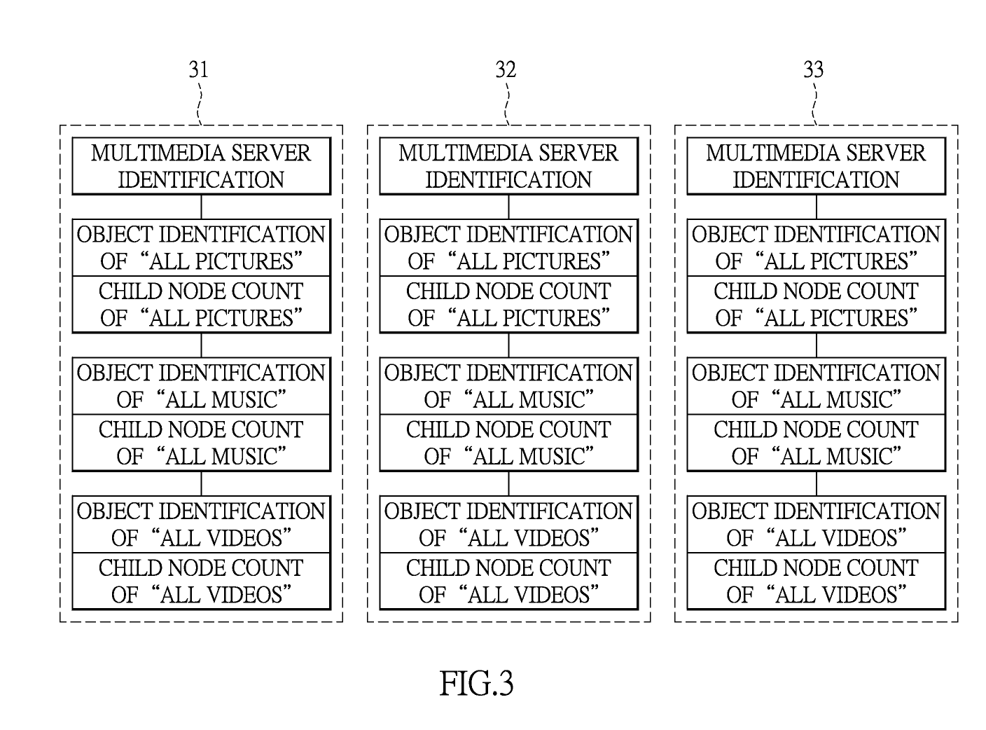

Referring to FIG. 3, FIG. 3 is a schematic diagram showing a data structure of multimedia information stored by a multimedia apparatus according to an exemplary embodiment of the present disclosure. The multimedia information 31 through 33 of the multimedia severs 131 through 133 is preferably stored as a list data structure, and comprises multimedia sever identifications, and the object identifications and the child node counts of the documents of “all pictures”, “all music”, and “all videos”. The multimedia sever identification points to the corresponding object identifications of the documents of “all pictures”, “all music”, and “all videos”, and the object identifications of the documents of “all pictures”, “all music”, and “all videos” point to the corresponding child node counts of the documents of “all pictures”, “all music”, and “all videos”.

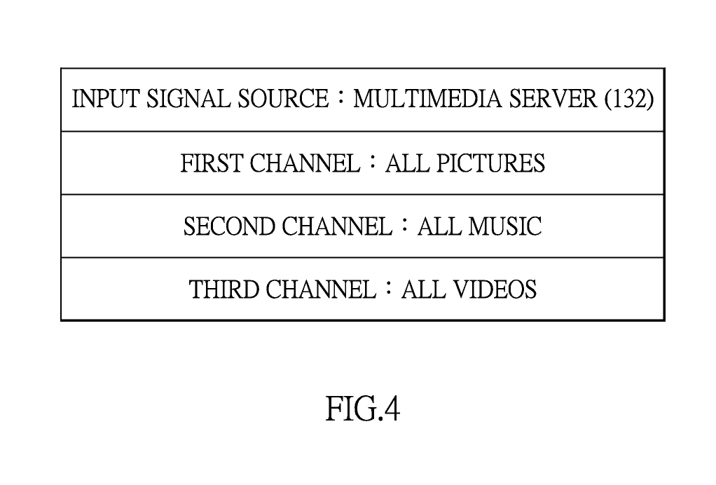

Referring to FIG. 4, FIG. 4 is a schematic diagram of a channelization browse interface provided by the multimedia apparatus according to an exemplary embodiment of the present disclosure. The multimedia apparatus 11 can present the multimedia information to the user by using a channelization browse interface (i.e. one-dimension presentation manner), such that the user can intuitively select the multimedia file to be watched or listened. In FIG. 4, the channelization browse interface shows the multimedia information of the multimedia server 132, the user can select the first channel to watch the picture files under the document of “all pictures”, the second channel to listen the music under the document of “all music”, or the third channel to watch the video under the document of “all videos”. After one of the first through third channels is selected, the multimedia apparatus 11 browses the multimedia files of the selected channel in real time, such that the user can watch or listen the multimedia file of the selected channel, wherein the multimedia files of the channel are sorted by file creation time in the descending order, for example.

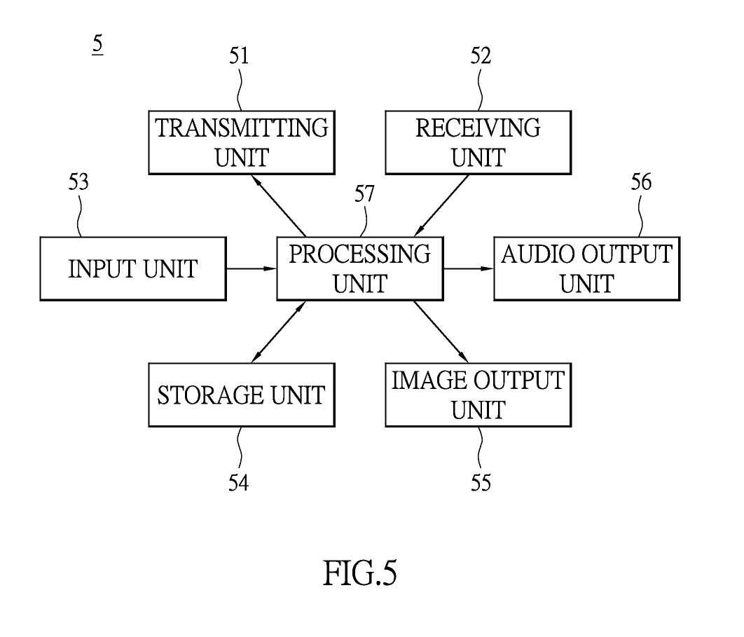

Referring FIG. 5, FIG. 5 is a block diagram of a multimedia apparatus according to an exemplary embodiment of the present disclosure. The multimedia apparatus 5 can comprise a transmitting unit 51, a receiving unit 52, an input unit 53, a storage unit 54, an image output unit 55, an audio output unit 56, and a processing unit 57, wherein the processing unit 57 is electrically connected to the transmitting unit 51, the receiving unit 52, the input unit 53, the storage unit 54, the image output unit 55 and the audio output unit 56.

The transmitting unit 51 transmits the information to the multimedia sever, such as the browse action command. The receiving unit 52 receives the response information (such as the response information in XML format) and multimedia stream from the multimedia sever. The user can perform input operation by using the input unit 53, so as to select the channel and the multimedia server correspondingly. The storage unit 54 can store the multimedia information and the multimedia stream. The image output unit 55 can output the image of the multimedia stream. The audio output unit 56 can output the audio of the multimedia stream.

The processing unit 57 is used to control the transmitting unit 51, the receiving unit 52, the input unit 53, the storage unit 54, the image output unit 55, and the audio output unit 56. In addition, the processing unit 57 can generate the browse action command and analyze the response information, so as to obtain the multimedia information and indicate the storage unit 54 to store the multimedia information. The processing unit 57 can further process the multimedia information, and control the image output unit 55 to provide the channelization browse interface to the user.

It is noted that the multimedia apparatus 11 can be implemented by using the implementation of the multimedia apparatus 5. However, the present disclosure is not limited thereto, and the multimedia apparatus 11 can be implemented by other implementations.

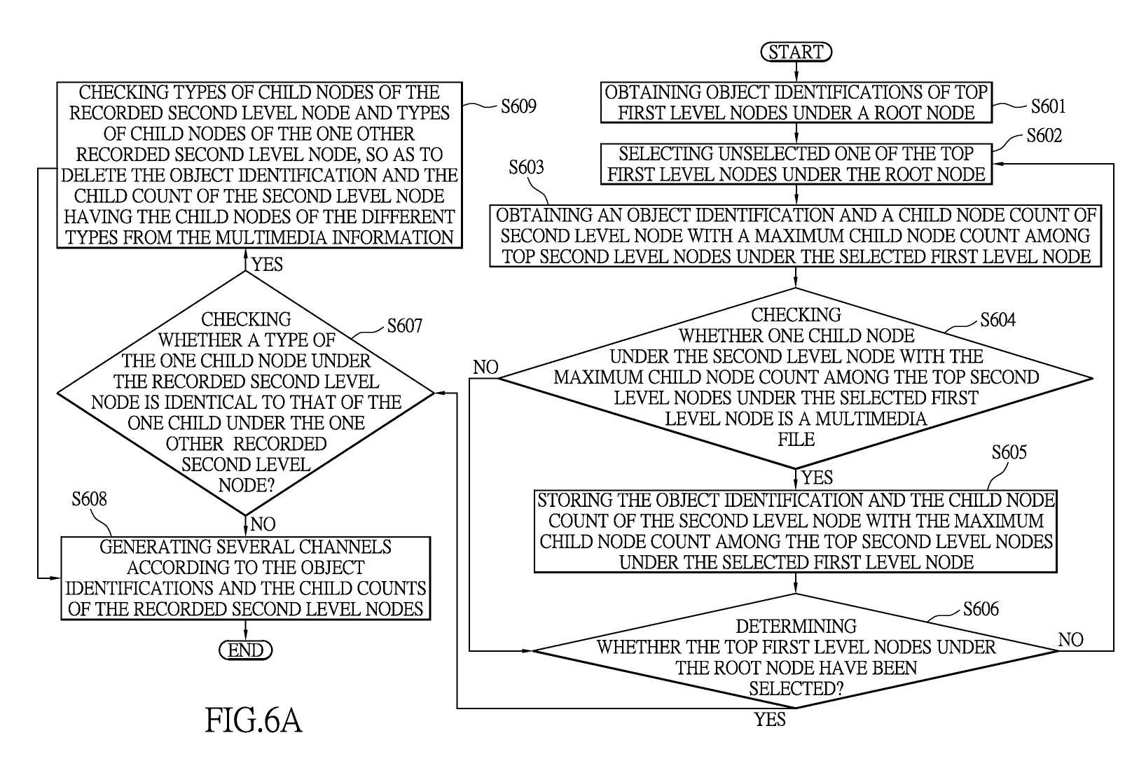

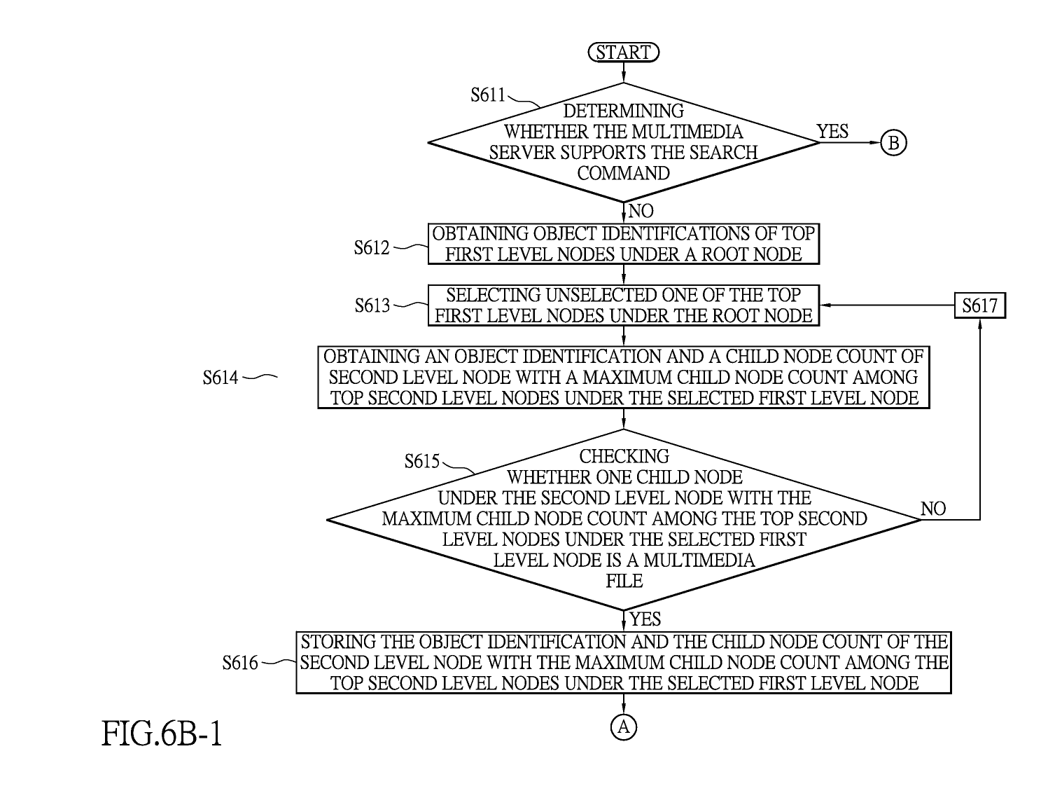

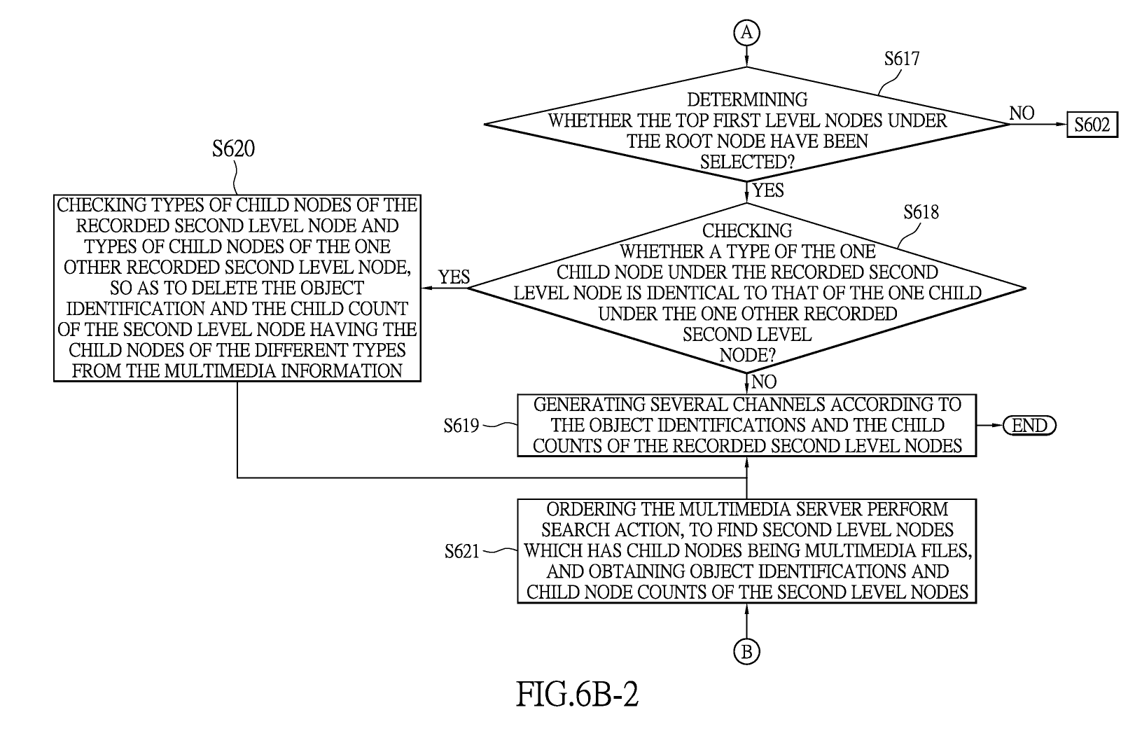

Referring to FIG. 6A, FIG. 6A is a flow chart of a multimedia information processing method according to an exemplary embodiment of the present disclosure. The multimedia information processing method can be executed in the above multimedia apparatus 11 or 5, but the present disclosure does not limit the apparatus for executing the multimedia information processing method.

Firstly, at step S601, the multimedia apparatus obtains the object identifications of the top first level nodes under the root node of the multimedia server. To put it concretely, the multimedia apparatus sends the browse action command to the multimedia sever, so as to obtain the response information from the multimedia sever. The multimedia apparatus can analyze the response information to obtain the object identifications of the top first level nodes. In the exemplary embodiment, the number of the top first level nodes can be 4.

Then, at step S602, the multimedia apparatus selects unselected on of the top first level nodes under the root node. Then, at step S603, the multimedia apparatus obtains the object identification and the child node count of the second level node with the maximum child node count among the top second level nodes under the selected first level node. The multimedia apparatus sends the browse action command to the multimedia server according to the object identification of the selected first level node, so as to obtain the object identifications and the child node count of each of the top second level nodes under the selected first level node. Thus, the object identification and the child node count of the second level node with the maximum child node count among the top second level nodes can be obtained. In the exemplary embodiment of the present disclosure, the number of the top second level nodes can be 4.

Next, at step S604, the multimedia apparatus checks whether one child node of the second level node with the maximum child node among the top second level nodes under the selected first level node is the multimedia file. To put it concretely, the multimedia apparatus obtains the type of the one child node of the second level node by sending the browse action command to the multimedia server according to the object identification of the second level node obtained at step S603. If the type of the child node is the picture, music, or video, the child node is determined to be the multimedia file, and step S605 is executed. If the type of the child node is the picture, music, and video, the child node is not determined to be the multimedia file, and step S606 is executed.

At step S605, the multimedia apparatus stores the object identification and the child node count of the second level node with the maximum child node count among the top second level nodes under the selected first level node. Since the one child node of the second level node with the maximum child node count is not determined to be the multimedia file at step S604, the second level node with the maximum child node count is reasonably inferred to be the document of “all pictures”, “all music”, or “all videos”, and the multimedia apparatus stores the object identification and the child node count of the second level node with the maximum child node count. After step S605 is executed, step S606 is then executed.

Then, at step S606, the multimedia apparatus determines whether the top first level nodes under the root node have been selected. If the top first level nodes under the root node have been selected, step S607 is executed next. If the top first level nodes under the root node have not been selected, step S602 is executed.

At step S607, the multimedia apparatus checks whether the type the one child node of the second level node is identical to the type of the one child node of another one second level node. If the type the one child node of the recorded second level node is identical to the type of the one child node of another one recorded second level node, step S609 is executed. If the type the one child node of the second level node is not identical to the type of the one child node of another one second level node, step S608 is executed. At step S608, the multimedia apparatus generates multiple channels according to the object identifications and the child node counts of the recorded second level nodes, wherein each channel has the multimedia files of the same type to be watched or listened. At step S609, the multimedia apparatus checks types of child nodes of the recorded second level node and types of child nodes of the one other recorded second level node, so as to delete the object identification and the child node count of the second level node having the child nodes of the different types from the multimedia information.

Referring to FIG. 6B-1 and FIG. 6B-2, FIG. 6B-1 and FIG. 6B-2 are a flow chart of a multimedia information processing method according to another one exemplary embodiment of the present disclosure. Compared to exemplary embodiment of FIG. 6A, the multimedia information processing method in FIG. 6B-1 and FIG. 6B-2 further comprises steps S611 and S621, and steps S612 through S620 are respectively identical to steps S601 through S609, and the repeated descriptions of steps S612 through S620 are thus omitted.

At step S611, the multimedia apparatus determines whether the multimedia server supports the search command. The multimedia apparatus transmits the polling action command to the multimedia sever to poll the multimedia sever whether the multimedia sever supports the search command, and the multimedia sever generates the response information indicating whether the search command is supportable to the multimedia apparatus. If the multimedia sever does not support the search command, step S612 through S620 are executed next, that is, the multimedia apparatus performs the browse action for the multimedia sever to obtain multimedia information as mentioned above.

If the multimedia sever supports the search command, step S621 is executed. At step S621, the multimedia apparatus orders the multimedia sever to perform the search action, to find the second level nodes having the child nodes which are the multimedia files, and obtain the object identifications and the child node counts of the second level nodes. Next, after step S621 is executed, step S620 is executed.

Accordingly, the multimedia apparatus and multimedia information processing method provided by exemplary embodiments of the present disclosure can obtain object identifications and child node counts of the documents corresponding to the multimedia files without looking look over the whole directory structure, and thus computation amount, memory usage, storage space usage, and network traffic amount can be dramatically reduced. Furthermore, the multimedia apparatus and the multimedia information processing method can present the multimedia information to the user through the channelization browse interface, such the user can intuitively and select the multimedia file with facility.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A multimedia apparatus linked to a multimedia server, comprising:
a transmitting unit, transmitting a browse action command to the multimedia server, wherein the multimedia server generates response information according to the browse action command;
a receiving unit, receiving the response information;
a storage unit, storing multimedia information; and
a processing unit, electrically connected to the transmitting unit, the receiving unit, and the storage unit, generating the browse action command, analyzing the response information, and thus generating multimedia information;
wherein the multimedia server has a root node, there are first level nodes under the root node, and there are second level nodes under each of the first level nodes; for each of the top first level nodes, among the top second level nodes under the first level node, the processing unit finds the second level node with a maximum child node count; then the processing unit indicates the storage unit to store object identifications and the child node counts of partial found second level nodes as a part of the multimedia information.

2. The multimedia apparatus according to claim 1, wherein if one child node under the found second level node is a multimedia file, the processing unit indicates the storage unit to store the object identification and the child node count of the found second level node as the part of the multimedia information.

3. The multimedia apparatus according to claim 2, wherein the processing unit obtains object identifications of the top first level nodes; for each of the top first level nodes, among the top second level nodes under the first level node, the processing unit finds the second level node with the maximum child node count, and then obtains the object identification and the child node count of found second level nodes; for each of the found second level nodes, if the one child node under the found second level node is the multimedia file, the processing unit indicates the storage unit to store the object identification and the child node count of the found second level node as the part of the multimedia information.

4. The multimedia apparatus according to claim 2, wherein the processing unit checks whether a type of the one child node under the found second level node is identical to that of the one child under the one other found second level node, if the type of the one child node under the found second level node is identical to that of the one child under the one other found second level node, the processing unit checks types of child nodes of the found second level node and types of child nodes of the one other found second level node, so as to indicate the storage unit to delete the object identification and the child node count of the found second level node having the child nodes of the different types from the multimedia information.

5. The multimedia apparatus according to claim 1, wherein a number of the top first level nodes is less than or equal to 4, and a number of the top second level nodes under the first level node is less than or equal to 4.

6. The multimedia apparatus according to claim 1, wherein the multimedia information is stored as a list data structure, and the multimedia information comprises a multimedia server identification, the object identifications and the child node counts of the found second level nodes, wherein the multimedia server identification points to the object identifications of the found second level nodes, and the object identifications of the found second level nodes respectively point to the child node counts of the found second level nodes.

7. The multimedia apparatus according to claim 1, further comprising:
an image output unit, electrically connected to the processing unit, wherein the processing unit processes the multimedia information, and controls the image output unit to provide a channelization browse interface for a user.

8. A multimedia network system, comprising:
at least one multimedia apparatus; and
at least one multimedia server, linked to the multimedia apparatus, and has a root node, wherein there are first level nodes under the root node, and there are second level nodes under each of the first level nodes;
wherein the multimedia apparatus obtains object identifications of top first level nodes; for each of the top first level nodes, among the top second level nodes under the first level node, the multimedia apparatus finds the second level node with the maximum child node count, and then obtains the object identification and the child node count of the found second level node; for each of the found second level nodes, if one child node under the found second level node is the multimedia file, the multimedia apparatus stores the object identification and the child node count of the found second level node as a part of multimedia information.

9. The network system according to claim 8, wherein a number of the top first level nodes is less than or equal to 4, and a number of the top second level nodes under the first level node is less than or equal to 4.

10. The network system according to claim 8, wherein the multimedia information is stored as a list data structure, and the multimedia information comprises a multimedia server identification, the object identifications and the child node counts of the found second level nodes, wherein the multimedia server identification points to the object identifications of the found second level nodes, and the object identifications of the found second level nodes respectively point to the child node counts of the found second level nodes.

11. The network system according to claim 8, wherein the multimedia apparatus processes the multimedia information to provide a channelization browse interface for a user.

12. The network system according to claim 8, wherein the multimedia apparatus checks whether a type of the one child node under the found second level node is identical to that of the one child under the one other found second level node, if the type of the one child node under the found second level nodes is identical to that of the one child under the one other found second level node, the multimedia apparatus checks types of child nodes of the found second level node and types of child nodes of the one other found second level node, so as to delete the object identification and the child node count of the found second level node having the child nodes of the different types from the multimedia information.

13. A multimedia information processing method executed in a multimedia apparatus linked to a multimedia server, the multimedia server has a root node, there are first level nodes under the root node, there are second level nodes under each of the first level nodes, and steps of the multimedia information processing method comprise:
the multimedia apparatus obtains object identifications of top first level nodes;
for each of the top first level nodes, among the top second level nodes under the first level node, the multimedia apparatus finds the second level node with the maximum child node count, and then obtains the object identification and the child node count of the found second level node;
for each of the found second level nodes, if one child node under the found second level node is the multimedia file, the multimedia apparatus stores the object identification and the child node count of the found second level node as a part of multimedia information.

14. The multimedia information processing method according to claim 13, wherein a number of the top first level nodes is less than or equal to 4, and a number of the top second level nodes under the first level node is less than or equal to 4.

15. The multimedia information processing method according to claim 13, wherein the multimedia information is stored as a list data structure, and the multimedia information comprises a multimedia server identification, the object identifications and the child node counts of the found second level nodes, wherein the multimedia server identification points to the object identifications of the found second level nodes, and the object identifications of the found second level nodes respectively point to the child node counts of the found second level nodes.

16. The multimedia information processing method according to claim 13, further comprising:
the multimedia apparatus processes the multimedia information to provide a channelization browse interface for a user.

17. The multimedia information processing method according to claim 13, further comprising:
the multimedia apparatus checks whether a type of the one child node under the found second level node is identical to that of the one child under the one other found second level node; and
if the type of the one child node under the found second level nodes is identical to that of the one child under the one other found second level node, the multimedia apparatus checks types of child nodes of the found second level node and types of child nodes of the one other found second level node, so as to delete the object identification and the child node count of the found second level node having the child nodes of the different types from the multimedia information.
